(19) United States
(12) Patent Application Publication
(10) Pub. No.: US 2011/0232185 A1
(43) Pub. Date: Sep. 29, 2011

(54) Collapsible rack and row planters

(76) Inventor: William Ahmadi, (US)

(21) Appl. No.: 12/798,002

(22) Filed: Mar. 29, 2010

(51) Int. Cl. A01G 9/02

(52) U.S. Cl. 47/66.6

(57) ABSTRACT

A collapsible rack and row self watering planter and rain water collection system consists of a fully enclosed frame of columns and rows of planters used to grow crops or plants on a small or large scale. Each row of planters consists of at least one horizontal wick tube spanning the distal length of said row, whereby each planter of said row is individually irrigated by means of a plurality of rubber wick hoses which in turn are fed from the horizontal wick tube. Rain channels and gutters are built along the perimeter of said unit to catch and store rain water in the poly mesh storage reservoir. A solar panel sits aside or atop the unit to gather solar energy and in addition, when mounted atop said frame, provides shading for the planters. A plurality of wind turbines are mounted along the main frame atop, or beside the unit and act to gather wind energy. Both solar and wind energy are stored in battery units or sent to nearby power grids.

### BACKGROUND INFORMATION

1. Field of the Invention

A collapsible rack and row self watering row planter with rain water collection and solar power system relates to a self watering stacked row planter unit in the area of large or small agricultural growers.

2. Background Art

Stacked row planters are well known in the art and are meant to increase the yield of a given crop by effectively increasing the productivity of a given amount of growing space therein. One of the major disadvantages of traditional row planters is that conventional cultivators cannot handle the close spacing of traditional row planters, and as a result crop yield is lost due to the less efficient use of land.

### PRIOR ART

Stackable row planters are well known in the art. Many different versions exist, however most if not all deal with single entity planters. For example U.S. Pat. No. 5,136,807 Orlov discloses a multiplicity of containers which are stacked to form a self supporting column. Irrigation is achieved by means of a downward water flow whereby the excess water at one level overflows down to the next level through each of the aperture containers through a drainage system. Although this system supports columns of planters, the present invention supports large areas of planters along columns and rows. U.S. Pat. No. 6,520,100 Spooner et al. discloses a twin row planter configured into two rows with spacing effectively simulating a single row to effectively increase crop yield. U.S. Pat. No. 5,305,551 Orlov Apr. 26, 1994 discloses a column planter consisting of a plurality of planting pots that are stacked whereby a central hole runs the length of the planter. A water storage tank exists at the base whereby water is pumped upwards along the tube to trickle down passing from one pot to overflow into another below thereby irrigating each planter the remaining water left to be re circulated by the pump.

Finally U.S. Pat. No. 7,392,616 Bagby Jul. 1, 2008 discloses a modular planting system for rooftops whereby a minimum of two tray members are used, one as water source the other as a growing medium. A wicking material is employed to provide moisture to the growing member from the water tray.

All of the above mentioned prior art has merit in one way or another however the present invention incorporates a superior wicking mechanism to moisten said planters. In addition, the present invention provides a means to gather and store rain water as its source. The present invention also allows for a far greater number of planters that are stacked in rows and columns, called racks, to be irrigated within this system, in addition to providing an easier method of harvesting crops during peak harvesting season. It is the only large scale collapsible self watering planter system that exists, so far as my study of prior art has revealed.

### OBJECT

### Summary of the Invention

An object of the current invention is to provide a plurality of fully contained rack track of row planters of a plurality of sizes and specifications, aligned horizontally across a minimum of two per row, and vertically up in a plurality of differing levels, whereby each planter is self watering by means of a plurality of rubber wick tubes secured to a water source raised slightly above that of the planter itself.

The objects stated above have been achieved by means of a framing structure built around individual planters wherein a wick housing tube is bounded on either side by a planter on either side, running the length of the structure and enclosed by an air tight sealed end cap on either end. This wick housing tube is supplied moisture which is then transferred to the individual planters.

Another object of the invention is to collect its own water supply by means of a rainwater collection system consisting of flap topped gulley's and channels aligning the peripheral top of the structure.

That object is achieved as rain water is sent from the channels down the gulleys along to an underground cement lined poly mesh storage reservoir that is fully sealed and airtight The rubber wick tube emerges from the wick housing tube on one end, the other, buried at the level of the root ball in the planter delivers moisture to the plant. Each planter consisting of a plurality of rubber wick tubes. Each rubber wicks tube consists of a plurality of wicking materials and said wicking material is enclosed within a synthetic netting tied at the ends of each rubber wicks tube to increase the capillary action of the wicks in watering each planter.

Another object of the invention is to provide a direct source of solar energy for use by local providers. This object is achieved by means of attaching a solar panel atop the rack track unit. The solar panel effectively acts a natural shade for the planters in the racks below guarding against burn of the plants. The panel also acts as a water flow guide whereby rain water is guided along the peripheral borders of said solar panel and effectively dumps water into the surrounding channels which themselves empty into the rain water gutters and into the poly mesh storage reservoir

A final object of the invention is to provide a growing means to a plurality of planters that can be stacked along a plurality of columns and rows.

This object is achieved by means of a frame of L- or U-shaped interlocking pipes made form a plurality of materials act as the support structure for the individual planters along the length of the rack track system.

In this way a plurality of planters can be stacked one above another along the length of the track. The planters are secured to the outer frame by sub frame braces running perpendicular to the frame piping and acts as a securing brace for the planter. The sub frame brace is directly attached to the outer frame by means of screws or bolted nuts. The planter slides into the brace from above coming to reset on the planter shelves which consists of a plurality of materials, drops into a slotted enclosure along the units frame where the sub frame meets said frame member and are fastened to the outer frame by a series of nuts and bolts.

An alternative embodiment provides a dual generator wind turbine which can consist of a single shaft, or of a shaft less center portion of the turbine whereby a generator is connected to said wind turbine by means of mini shafts.

Accordingly a major concern of the present invention is the conservation of water. By incorporating self watering features wasted water can greatly by scaled back. For example, to irrigate an acre of plant container area with one inch of water would require 27,000 gallons of water, 90% of which is wasted in runoff. Thus the benefits of the present invention include efficient water management, pesticide run—off management, liquid fertilizer run-off management, nutrient extraction, increased crop yield per square foot, and recycling rain water for agricultural purposes, organic crop, convenience of harvesting, and a completely collapsible transportable rack track unit.

### DRAWINGS

### Brief Description of the Drawings

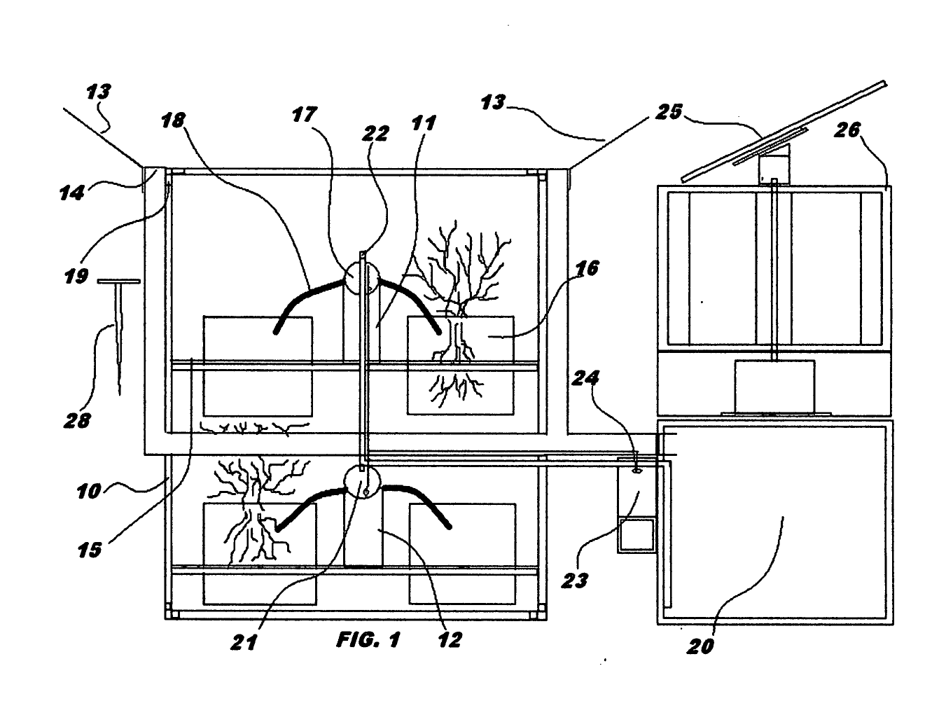

FIG. 1 is a front view of the collapsible rack row self watering row planter. In this embodiment the unit is attached to a wind turbine sitting atop a storage reservoir.

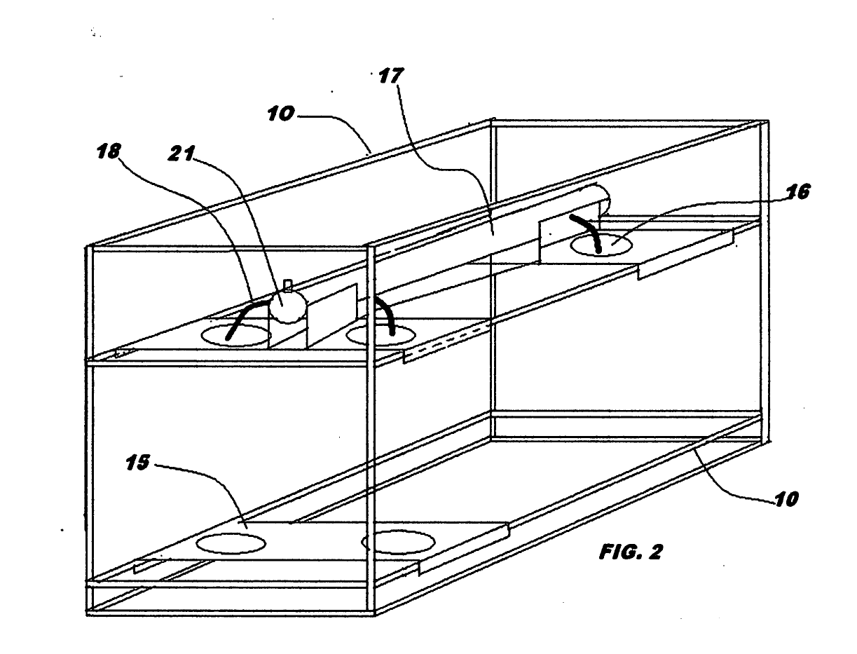

FIG. 2 is an angled view of front and side frame

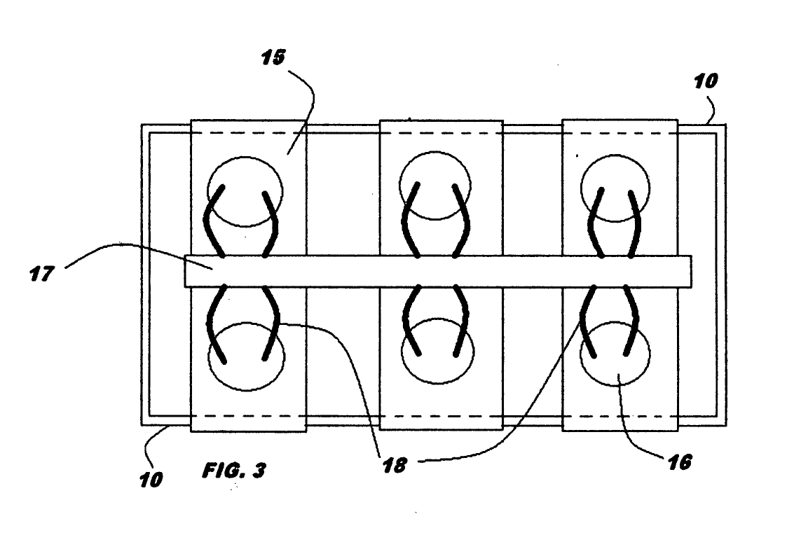

FIG. 3 is a sectional view from above the collapsible rack and row

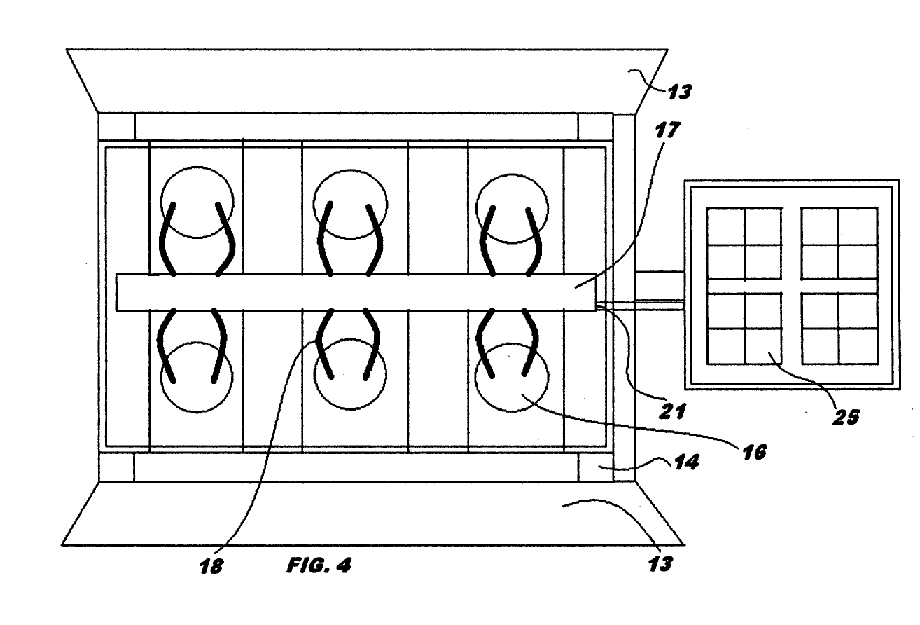

FIG. 4 is a top view of the rack and row unit

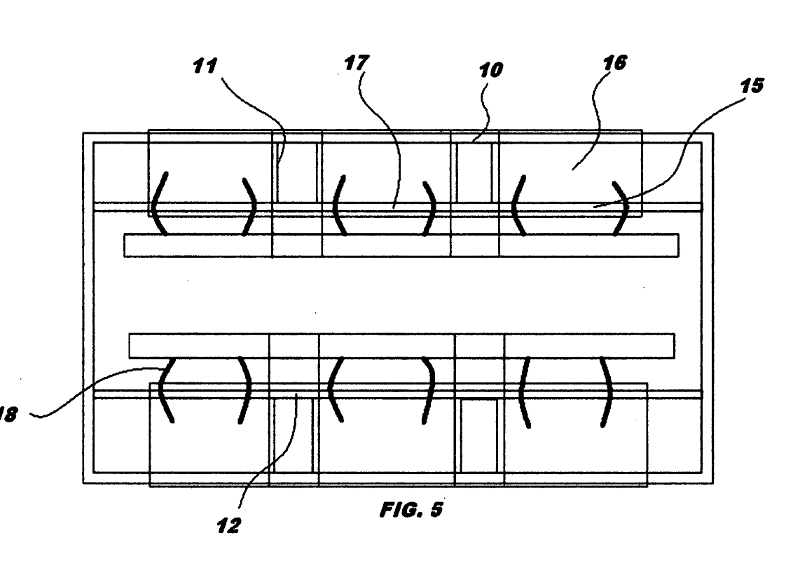

FIG. 5 is a side view with frame, planters and watering mechanism of the rack and row unit.

### DETAILED DESCRIPTION OF THE DRAWINGS

Now moving on to the drawings, FIG. 1 demonstrates a front view of an embodiment of the present invention. The unit is housed within the main frame 10 composed of a plurality of plastic intersecting pipes that are easily screwed together into place and form the framing structure for the present invention. Attached vertically along the four corners of said main frame 10 are the rainwater collection gutters 14 which collect rain water and sends it to a reservoir or a series of polymesh storage reservoirs 20 which may be above or below ground. In between and attached to each pair of rainwater collection gutters 14 along the length of a given side are the upper horizontal water channel 11, on the upper level, and the lower horizontal water channel 12 on the lower level which intersects both rainwater collection gutters 14 and directs rainwater caught within to the gutters 14 whereby the rainwater is transported to the polymesh storage reservoir 20 for later use.

A water level sensor 24 monitors the water pressure and when said reservoir 20 is full allows for the release of water through a release valve. The reservoir pump 23 supplies the horizontal wick housing tube 17 with water and sufficient pressure to force water inside the wick housing tube 17 into the wick hoses 18 and eventually into said planters 16.

Said rainwater collection gutters 14 are topped with directional water channel flaps 13 which are angled such that rainwater is collected in a larger capacity by two outstretched angled water channel flaps 13 one pair for each corner of the unit.

And now moving into the interior portion of said unit we find a minimum of two levels of a plurality of planter units 16, a minimum of two per row, line the entire length of the collapsible rack track self watering unit. Affixed to a pair of said planter units 16 side is an upper horizontal water channel which secures the horizontal wick housing tube 17 which spans the length of the collapsible unit.

Each individual planter 16 is watered, and fed, if so desired, by a plurality of individual wick hoses 18. Said wick hose 18 is inserted at one end into the raised horizontal wick housing tube 17, relative to said planters 16, and descend down into the planter 16 at root level. A soil poker 28 is included to bore an opening deep into the soil at root level for insertion of the wick hose 18. A synthetic or non synthetic wick material 27 fills the void of the opening within said wick hose 18 and is extended at both ends, its entire area bounded in a netting material to increase the capillary action of the wick material 27. Each row of planters is held into place by sub frame brackets 15 that are attached to the main frame 10 on the exterior sides of the unit. Said sub frame brackets 15 are composed of a metallic sheet with a cutout of a plurality of shapes in the center of the metallic sheet which is bent downwardly in a vertical position relative to said main frame10 where it slides into a cradle position atop the main frame 10 piping.

Beside the collapsible track rack self watering row planter is a solar panel 25 affixed atop a dual generator wind turbine 26 which produces energy from natural resources, namely solar and wind power. The solar panel 25 and wind turbine 26 unit sit atop the water storage reservoir 20 made from expanded polystyrene filled walls in this embodiment. It is noted that other embodiments of the present invention place said water storage reservoir 20 underground.

FIG. 2 illustrates an angled frontal side view of the collapsible rack and row self watering row planters main frame 10 enclosing a structure that houses multiple rows and columns of planters 16.

Said planters 16 are housed in slide through openings in a plurality of shapes, extracted from said metallic panel, a given shape matches the corresponding planter 16, which is securely draped atop said main frame 10 piping.

What is learned in FIG. 2 is the practicality of the sub frame bracket 15 as a securing member of the planters 16

FIG. 3 is a top sectional view of a planter 16 row wherein two main frame 10 members on both sides of the main frame 10 enclosure, said sub frame bracket 15 extends the width of said rack and row unit forming a right degree angle bend fitting around the main frame 10 piping.

The horizontal wick housing tube 17 lies in the center of the unit parallel to said main frame 10 piping, supported by upper horizontal water channel 11 or lower horizontal water channel 12, depending on the rack level, two are indicated in the present embodiment of the present invention. Arising along the channel between each planter 16 is a support structure with a concave cutaway which allows said wick housing tube 17 to rest within these cutaways along the length of the rack and row unit. Said wick housing tube 17 is raised above the planters 16 which are embedded into a slot opening of the sub frame bracket 15. Wick hoses 18 descending from said horizontal wick tube 17 are filled with a wick material 27 of synthetic or non synthetic materials and fibers, the opposing ends of said wick hoses 18 buried beneath the soil of the planter 16, into a hole created by a soil poker 28 whereby the wick hose 18 reaches the root level of the plant. A plurality of wick hoses 18 are buried into the soil of each individual planter 16

All four sides of said planter 16 are secured and held into place by the sub frame bracket 15 by a cutaway opening in the center of said sub frame bracket 15. The planter 16 slides down into the slot until its continual extending perimeter is trapped into place by the slot opening, which comes in a plurality of shapes to match different planter 16 shapes.

FIG. 4 is a top view of the rack and row unit where we find the angled and extended walls of said water channel flaps 13 along the length of both sides of the main frame 10. The two extended angled walls of the water channel flaps 13 are directly attached to said rainwater collection gutter 14 which runs the length of the rack and row unit along the top edges. The water caught within said gutters 14 is directed to a storage reservoir 20 which has a plurality of lines leading to the multiple levels of said rack and row unit, and are attached to said horizontal wick housing tubes 17 end caps 21 which enclose each end of said wick housing tube 17 leaving it sealed and air tight. The aforementioned end caps 21 receive said lines from the reservoir where water is pumped to the wick housing tube 17 by means of a reservoir pump 23 attached to said storage reservoir 20 thereby delivering water and nutrients to the planters 16 by a plurality of wick hoses 18, per planter 16. The upper horizontal water channel 11 and the lower horizontal water channel 12 are channels on each rack level where the horizontal wick housing tube 17 is housed in a raised position relative to said planters 16. The sub frame bracket 15 consists of a singular planar shaped metallic or plastic body stretching the width of said rack and row unit, its ends bent downwards at a right angle to slide over and rest on each side of said main frame 10 piping.

Positioned beside the rack and row unit is the top view of said soar panel 25, beneath which the wind turbine 26 is mounted atop the poly mesh water storage reservoir 20. Said solar panel 25 and dual generator wind turbine 26 act to gather energy and transmit said energy to a battery storage facility or where desired.

A side view of FIG. 5 is provided whereas said planters 16 and the infrastructure are provided as opposed to FIG. 2 which illustrates the framing of the structure. In FIG. 5 the main frame 10, with corners attached together by screw on L-clamps, at least one for every intersecting point of said frame, houses two racks of individual planters 16 where a side view of the sub frame brackets 15 are revealed as holding receptacles for said planters 16 which slide into the pre designed opening in said sub frame bracket 15, where said openings are composed of a plurality of shapes and sizes to match that of a given planter 16.

Aligned above said planters 16 along the center of the rows is housed the horizontal wick housing tube 17 which consist of a plurality of openings for wick hoses 18 to descend from inside said horizontal tube 17 deep within said planter 16 to deliver moisture to the plants at the root level. The moisture is transferred by a wick method wherein wicking material 27 is inserted into said wick hoses 18 where it is exposed on both ends and bound in a netting material to aid capillary action.

In other embodiments a plurality of racks and rows are possible. For example a rack and row unit may be constructed to support four racks with a row of say twenty planters along each side, or any number of racks or rows as is so desired.

### LIST OF DRAWING REFERENCES

10) Main frame
11) Upper horizontal water channel
12) Lower horizontal water channel
13) Water channel flaps
14) Rain water collection gutter
15) Sub frame bracket
16) Planter
17) Horizontal wick housing tube
18) Wick hose
19) Bracket screw/nuts and bolts
20) Poly mesh storage reservoir
21) End cap
22) Water refill nozzle
23) Reservoir pump
24) Water level sensor
25) Solar panel
26) Wind turbine
27) Wicking material
28) Soil poker

### CONCLUSIONS, RAMIFICATIONS AND SCOPE

Accordingly the reader will note that the collapsible rack and row self watering row planter with rain water collection system is a fully contained and transportable system of a plurality of planter columns and rows which can be custom built in a plurality of sizes to serve a large scale number of planters.

Furthermore the present invention has multiple advantages that:

1—Allow for the self watering of each individual planter;
2—Gathers and stores rain water for use of irrigating said planters;
3—Allows for ease of harvesting;
4—Gathers and stores solar and wind energy;

Although the above description contains many specifications, these should not be construed as limiting the scope of the invention but merely providing illustrations of the preferred embodiments of this invention, thus the scope of this invention should be determined by the appended claims and their legal equivalents, rather than by the examples given.

What is claimed is:

1. A collapsible rack and row self watering row planter with rain water collection system wherein the exterior chassis framing consists of a plurality of individually connected pipes aligned along vertical and horizontal paths of an intersecting rectangle of a plurality of materials which form the frame housing and support of the unit.
A plurality of sub frame brackets, which also act as planter racks, in a plurality of shapes and sizes, are affixed to the frame in a plurality of intersecting points along the units frame by means of sliding onto and resting on said frame, and act as structural support by means of a plurality of cylindered openings within said sub frame bracket wherein the bracket acts as overall support to the main frame and as a planter slot through which lower and mid portions of said planter slide through until held into place.
Atop the peripheral sides of the structure is a channel flap on either side of the structure is a metallic flap angled from between 45 and 65 degrees of the vertical siding on each peripheral corner top of the structure allowing for the trapping of rainwater through the channels to a gutter composed of a plurality of metallic materials positioned vertically whereby rain water is fed into an underground storage reservoir completely sealed and airtight.
Along the central portion and atop, the structure is attached a solar panel which lies parallel to said sub frame brackets in a slightly raised position to allow for the collection of energy and the displacement of rainwater into the channels on either side of said panel.
Attached along at least one said peripheral corner top of said structure is a wind turbine for the production of energy.
A central vertical post in a plurality of shapes acts as a central support stud for the entire structure attached to said sub frame brackets by means of nuts and bolts.
Aligned horizontally along the center of the structure is a horizontal wick housing tube running the length of the entire structure, a planter on either side, whereby said tube consisting of a plurality of openings along its surface into which a plurality of rubber wicks transfer moisture from said wick housing tube to planter.
An end cap forms an airtight seal on either end of said wick housing tube from which an opening leads to a refill nozzle whereby the wick tube is replenished from said nozzle whose other end is attached to the underground poly mesh storage reservoir.
Attached to said end cap is a pump directly attached to a water level sensor.

2. A collapsible rack and row self watering row planter with rain water collection system according to claim 1, wherein the main housing frame piping consists of L or U shaped pipes in a plurality of materials and are connected by snap on or screw on action. Said main frame is featured in a plurality of sizes and amounts of racks and rows of planters that are possible

3. A collapsible rack and row self watering row planter with rain water collection system according to claim 1, wherein said sub frame bracket encloses two planters on either side of a central structure housing a horizontal wick housing tube along its center. Said bracket affixed to said main frame on either border by means of screws or nuts and bolts.

4. A collapsible rack and row self watering row planter with rain water collection system according to claim 3, whereby said sub frame bracket consists of a plurality of evenly spaced central openings in a planar sheet of metal, plastic or wood, in a plurality of shapes, wherein said planters are housed by means of insertion of planter into said opening.

5. A collapsible rack and row self watering row planter with rain water collection system according to claim 1, wherein said central vertical post acts as the central stud, if needed due to a larger size, its upper end affixed to the rack track ceiling for support, its bottom attached directly to the ground.

6. A collapsible rack track self watering row planter with rain water collection system according to claim 5, wherein said central vertical posts comes in a plurality of shapes.

7. A collapsible rack and row self watering row planter with rain water collection system according to claim 1, wherein said horizontal wick tube is aligned centrally parallel to the outer frame. Said wick housing tube slightly elevated in relative position to that of the planters affecting wick hose to flow in a manner perpendicular to the ground.

8. A collapsible rack and row self watering row planter with rain water collection system according to claim 3, wherein said sub frame bracket acts as a planter rack and runs parallel to and below the central wick tube on either side whereby individual planters are placed within a cut out section of said sub frame bracket and said bracket is attached to frame by means of a perpendicular bend, to the frame pipes, which slides over and comes to rest upon said main frame, at a plurality of intersections along the units frame.

9. A collapsible rack and row self watering row planter with rain water Collection system according to claim 7, wherein said horizontal wick tube is enclosed on either distal end by an end cap consisting of a plurality of openings.

10. A collapsible rack and row self watering row planter with rain water collection system according to claim 7, wherein said horizontal wick tube consists of a plurality of openings along a cylindrical surface whereby rubber wick tubes are inserted through said horizontal wick tube, the other end leading to said planter at a depth near the root ball to provide moisture directly to the plant.

11. A collapsible rack and row self watering row planter with rain water collection system according to claim 1, wherein said rainwater collection gutters form a planar or a slightly concave surface extending outwardly from said solar panels axis, encompassing the entire area of said housing frame along the entire upper segment of the unit attached by means of nuts and bolts, or screws evenly spaced along a plurality of places on said housing main frame.

12. A collapsible rack and row self watering row planter with rain water collection system according to claim 1, wherein said channel flaps are attached directly to the outer portion the rain water collection gutters by means of screws, nuts and bolts or tongue and groove inserters along the entire upper segment, at an outer angle of between no less than 55 and no more than 85 degrees and act as extensions of the channel to collect rain.

13. A collapsible rack and row self watering row planter with rain water collection system according to claim 1, wherein said rain water gutter runs parallel and is adjacent to said outer frame body adjacent to the four corner peripheral sides of the units body by means of a plurality of screws or nuts and bolts along even spacing's of said buildings sides. Said gutters run 90 degrees of the upper water channels. Said gutter consists of a squared profile wherein an opening beginning from rain channel extends downwardly forming an opening into the poly mesh water storage reservoir.

14. A collapsible rack and row self watering row planter with rain water collection system according to claim 1, wherein said poly mesh water storage reservoir is buried underground, or placed above ground as is desired, and is composed of a cement lining enclosing expanded polystyrene foam panels. Said reservoir completely sealed and airtight.

15. A collapsible rack and row self watering row planter with rain water collection system according to claim 1, wherein said refill nozzle consists of a pumping end within said water reservoir and a spray input nozzle on the opposing distal end. Said nozzle fits snugly into an opening of end cap and acts to refill said horizontal wick tube with moisture.

16. A collapsible rack and row self watering row planter with rain water collection system according to claim 9, wherein said end cap contains a plurality of openings for housing said refill nozzles within said horizontal wick tube.

17. A collapsible rack and row self watering row planter with rain water collection system according to claim 1, wherein said wind turbine is fastened to a plurality of main frame corner edges of said unit, attached to a post parallel to said main frame corner edge by means of a plurality of screws or nuts and bolts. Or said wind turbine is not directly attached to said rack and row unit.

18. A collapsible rack and row self watering row planter with rain water collection system according to claim 1, wherein said water level sensor connects to a pump along said horizontal wick tube, said pump connected to storage reservoir.

19. A collapsible rack and row self watering row planter with rain water collection system according to claim 15, wherein said pump is activated by water level sensor detecting low moisture level in said horizontal wick tube whereby water refill nozzles are activated to replenish moisture within said horizontal wick tube.
